(19) United States
(12) Patent Application Publication
(10) Pub. No.: US 2023/0281661 A1
(43) Pub. Date: Sep. 7, 2023

(54) PROBABILISTIC FREQUENCY CAPPING

(71) Applicant: Xandr Inc., New York, NY (US)

(72) Inventors: Romain QUÉRÉ, Quimper (FR); Yana VOLKOVICH, New York, NY (US); Chinmay Abhay NERURKAR, Jersey City, NJ (US)

(73) Assignee: Xandr Inc., New York, NY (US)

(21) Appl. No.: 18/110,136

(22) Filed: Feb. 15, 2023

Related U.S. Application Data
(60) Provisional application No. 63/316,712, filed on Mar. 4, 2022.

(51) Int. Cl. G06Q 30/0251; H04L 67/50; H04L 43/045; G06F 16/955

(52) U.S. Cl. CPC G06Q 30/0254; G06F 16/955; H04L 43/045; H04L 67/535

(57) ABSTRACT

Aspects relate to delivering directed content using frequency capping concepts without third-party cookie technology or other user-identifiable information. Systems and methods are described for determining an estimated number of impressions a user may view or experience based on historical, anonymized data. A covisitation graph is used to estimate the number of times an unidentified user may see an item of directed content, within in a predetermined period of time, based on a single visit to a particular website. The covisitation graph accounts for and also provides for estimated views of the item of directed content on other websites deemed related to the particular website. Therefore the estimated delivery rate for that website can be calculated and used to enforce frequency capping principals.

### CROSS REFERENCE TO RELATED APPLICATIONS

This application claims priority to and the benefit of U.S. Provisional Pat. Application No. 63/316,712, filed on Mar. 4, 2022, the disclosure of which is hereby incorporated herein by reference in its entirety.

### BACKGROUND

Computer users spend significant time these days browsing and viewing content on their computer devices. While browsing, users can unwittingly leave a digital footprint of their online activity which raises privacy concerns. Of particular worry is the use of third-party cookies, which can be used to track user activity on the Internet. While privacy concerns exist, publishers of directed content and/or advertisements, use the tracking data in a positive manner, i.e., to optimize placement of relevant advertisements as well as the cost of such placements. Such third-party cookies provide enough information that publishers can also use the information to prevent the over-delivery of the same advertisements to the same user, which is good for both the publishers and the end users. Limiting the over-delivery of such directed content is known as frequency capping. Unfortunately however, third-party cookies also capture and store other user data such that privacy concerns have led to the deprecation of such third-party cookies. Consequently, directed content publishers must find other ways to optimize directed content and other ad placement strategies.

It is with respect to these and other general considerations that the aspects disclosed herein have been made. In addition, although relatively specific problems may be discussed, it should be understood that the examples should not be limited to solving the specific problems identified in the background or elsewhere in this disclosure.

### SUMMARY

Aspects of the present disclosure relate to a system delivering directed content using frequency capping concepts without third-party cookie technology or other user-identifiable information. As described herein, the present disclosure relates to systems and methods for determining an estimated number of impressions a user may view or experience based on historical, anonymized data. From that estimate, aspects relate to determining a delivery rate for delivering directed content or other advertisements which controlling the frequency of such delivery.

The estimated rate that users may experience different impressions is estimated using an aggregated sample of user behavior on the Internet or other network, using anonymized data such as Internet Protocol addresses and/or other universal third-party identifiers. Using data related to browsing behavior, a covisitation graph. In embodiments, the covisitation graph is used to estimate the number of times an unidentified user may see an item of directed content, within in a predetermined period of time, based on a single visit to a particular website. The covisitation graph accounts for and also provides for estimated views of the item of directed content on other websites deemed related to the particular website. Therefore the estimated delivery rate for that website can be calculated and used to enforce frequency capping principals. Given that the delivery rate has been calculated, the backend processing can be simplified in that information on each specific user need not be tracked.

One or more aspects of the subject disclosure include receiving a frequency cap defining a number of impressions of an advertisement to be shown to content viewers, such as users visiting websites, creating a covisitation graph based on directed content request data (e.g., ad request data) in an online directed content delivery platform, the directed content request data related to directed contents shown to the users visiting the websites. Other aspects relate to determining an expected number of impressions that will be seen on a first website for visitors of the first website, and identifying, from data of the covisitation graph, one or more related websites having a relation to the first website. Aspects of the subject disclosure further include determining, from data of the covisitation graph, a probability for a visitor of the first website to be a visitor of each respective related website of the one or more related websites, determining an expected number of impressions seen on each respective related website for a user behind a bid request received on the first website, estimating an expected total number of impressions seen on the first website and the one or more related websites for a user behind a bid request received on the first website, based on the expected total number of impressions and the frequency cap, determining a delivery rate for impressions of the advertisement, and delivering impressions of the advertisement according to the delivery rate.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Reference will now be made to the accompanying drawings, which are not necessarily drawn to scale, and wherein:

FIG. 1 illustrates an exemplary, non-limiting embodiment of a frequency capping system and environment in accordance with various aspects described herein.

FIG. 2 shows an exemplary embodiment of an advertising platform that may be implemented to enable and/or enforce frequency capping in accordance with various aspects described herein.

FIG. 3 illustrates and exemplary representation of a covisitation graph in accordance with various aspects described herein.

FIG. 4 illustrates a functional block diagram for probabilistic frequency capping in an advertising platform in accordance with various aspects described herein.

FIG. 5 depicts an illustrative embodiment of a method related to creating and/or updating a covisitation graph in accordance with various aspects described herein.

FIG. 6 depicts an illustrative embodiment of a method related to delivering directed content using frequency capping in accordance with various aspects described herein.

FIG. 7 is a block diagram illustrating an exemplary, non-limiting embodiment of a virtualized communication network in accordance with various aspects described herein.

FIG. 8 is a block diagram of an exemplary, non-limiting embodiment of a computing environment in accordance with various aspects described herein.

FIG. 9 is a block diagram of an exemplary, non-limiting embodiment of a mobile network platform in accordance with various aspects described herein.

FIG. 10 is a block diagram of an exemplary, non-limiting embodiment of a communication device in accordance with various aspects described herein.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As mentioned above, the present disclosure describes, among other things, illustrative embodiments for enabling frequency capping for publishers of directed content, such as advertisements, without using third-party cookies or similar user-identifiable information, thereby protecting the privacy of the users. Systems and methods described herein use an aggregated sample of user on-line behavior based on anonymized information such as their internet protocol addresses or other universal third-party identifiers. The behavioral data can be used to create, update and/or maintain one or more covisitation graphs of related websites. Covisitation graphs indicate the probability that visitors of one site will visit another, related site. Using the probability information from the covisitation graph, the present disclosure can estimate an optimal delivery rate for publishers of directed content to use in deciding whether or not to purchase impressions on different sites according to desired frequency capping strategies.

A frequency cap corresponds to a limit on the number of items of directed content a user will experience over a set period of time. As used herein an item of directed content may include any advertisement or ad, such as display ads and video ads. As is known, frequency capping may be used to balance advertiser spend per user while achieving desired key performance indicators (KPIs).

Frequency capping may be implemented by an advertiser, an ad broker, an operator of an online advertising system or other party. In essence, a publisher of directed content (e.g., an advertiser), specifies a desired number of times in a specified or predetermined time period, such as 24 hours, two days, one week, etc., that a particular user may see a particular item of directed content or ad. In the past, advertisers could access a current “ad count” for each specific user (available using based on third-party cookie technology) and compare the ad count to the frequency cap. If the frequency cap was exceeded for the specified time period, the ad was suppressed and a new ad was selected and served/published. Suppression would continue until the ad count fell below the particular ad count for the particular ad. In accordance with aspects described here, the frequency capping is achieved without accessing an ad count or other specific user-identifiable information, as discussed below.

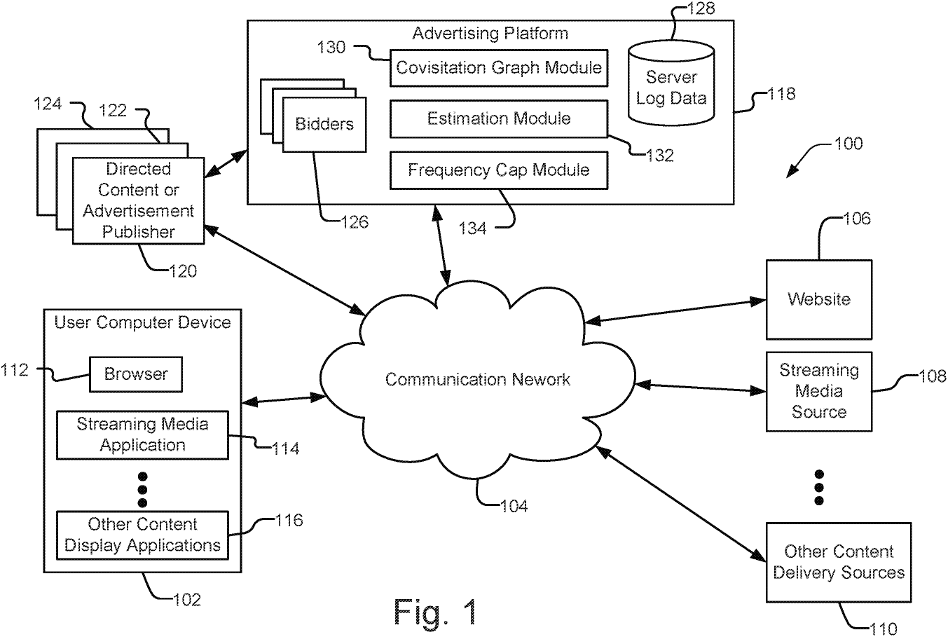

FIG. 1 illustrates an exemplary environment 100 used for frequency capping in accordance with various aspects described herein. As illustrated, environment 100 comprises a user computer device 102 for receiving and viewing content received over a communications network, such as network 104, from various sites or sources such as website 106, streaming media source 108 and/or other content delivery sources 110. As is known to those skilled in the art, the user computing device 102 may have, for example, a number of local applications to help facilitate the requesting and receiving of such content over the network, such as a browser 112, a streaming media application 114 and potentially other content display applications 116.

In an exemplary scenario, when viewing content from the website 106, the content may include designated space wherein an advertisement or other directed content may be inserted and displayed to the user. The process of identifying, locating and inserting such directed content is enabled by an advertising platform, such as advertising platform 118. Advertising platform 118 communicates with publishers of the directed content 120, 122 and 124, to identify, select and deliver the directed content. The process of selecting which item of directed content to display typically involves a bidding process where the publishers 120, 122 and 124 bid on available impressions and the advertising platform, through an auction, chooses a winning bid.

The publishers 120, 122 and 124 often communicate with “bidders” 126 within the advertising platform 118 to facilitate the functional operations of receiving bid opportunities and, in response serving bids to be used in the auction process. As will be appreciated, bid opportunities relate to impressions, which are the spaces within delivered content that may be purchased by the publishers 120, 122, and 124 to display their directed content, such as their advertisements. If a bid a chosen as the winner, then the winning bidder may further enable the communication of the selected item of directed content to be delivered/displayed to the user computer device 102 through the communication network 104. Those skilled in the art will appreciate the process of receiving bid opportunities, bidding on the same and fulfilling winning bids.

Advertising platform 118, in accordance with embodiments described herein, may further comprise server log data 128, a covisitation graph module 130, an estimation module 132 and a frequency cap module 134. The server log data relates to information identifying different user behavior recognized and logged by advertising platform 118. The information related to direct interactions between users and particular websites such gleaned from different data received such as different ad requests. In embodiments, the server log data may recognize receive multiple ad requests for the same or multiple websites but all from the same IP address. Consequently, without user-identifiable information, the server log data may log all websites visited by the system or device with that IP address. Other methods of logging server-side data may also be used.

The server log data 128 is used by covisitation graph module 130 to create one or more covisitation graphs. A covisitation graph corresponds to a graph of sites, such as website 106 as well as other websites (not shown) indicating the probabilities that visitors to one site will visit other, related websites, as discussed in more detail below. In embodiments for instance, the server log data 128 may indicate a user having a particular IP address visited different websites in succession, and therefore the covisitation graph module, using such information, can effectively associate the different websites and the probability of visitors to one site will visit the other one or more related websites.

The estimation module 132 effectively estimates the number of impressions a user may experience while visiting a particular website using server log data 128. As used herein, an impression refers to a space within a website, such as website 106 that an ad publisher, e.g., publisher 120 may purchase and use to display their directed content or advertisement. Those skilled in the art will be appreciate that estimating impressions is substantially similar to estimating the number of items of directed content or actual advertisements a user will experience while visiting a specific website.

As an example, the server log data may indicate that for one IP address visiting a specific website, e.g., CNN.com, fourteen different ad requests were submitted as bid opportunities, while other server log data may indicate that for another IP address visiting the same website, only ten ad requests were submitted. As a result, estimation module 132 may estimate that future visitors to that site may view twelve impressions, which is the average of actual impression views for that site within a predetermined period of time. Upon receiving more server log data, those skilled in the art will appreciate that more advanced techniques may be used to evaluate the server log data to estimate the number of impressions viewed per visitor, for each site.

In embodiments, estimation module 132 may further estimate the total number of impressions a visitor to a specific site may experience within a predetermined period of time given the probability that the user will visit other, related websites. The estimation module accesses probability information from the covisitation graph to enable the estimation of the total number of impression views for the visitor. In embodiments, the estimated total value is the sum of the number of estimated impression views on the first website added to a value related to the number of estimated views on the related website multiplied by the probability that visitor will visit that other website.

For instance, and continuing the above example, estimation module may estimate that a visitor to a specific website, such CNN.com, may view twelve impressions per hour (on average). The covisitation graph may indicate that visitors to CNN.com have a 50% probability of visiting another website, such BBC.com. The estimation module may further estimate that each visitor of the other website, e.g., BBC.com, view approximately six impressions per hour (on average). Consequently, the estimation module may increase or decrease the overall estimation of total impressions a visitor may experience based on the probability of visiting one or more other websites. In this example, given the high probability that a visitor to CNN.com will also visit BBC.com, the estimated number of impressions may increase from twelve to approximately fifteen impressions an hour.

Bidders 126 use the estimation information from estimation module 132 to enforce frequency capping, potentially using a frequency cap module 134. Frequency cap module 134, in an embodiment, may communicate with each bidder 126 to determine a number of impressions a particular publisher 120, 122, and/or 124 may want use as an upper limit in their campaigns to prevent any one item of directed content or advertisement to be delivered to any one specific user. Such frequency capping is helpful to the publisher and the end user because, if ad frequency is too high, the effectiveness of the ad decreases or worse, the ad can become irritating to the user. Accordingly, advertisers and users alike respect the value of frequency management.

Using the frequency cap module 134, bidders 126, and in essence, publishers 120, 122 and 124 may limit the number of impressions purchased and ultimately delivered to a particular user upon receipt of a single ad request, and without any other user-identifiable information behind the single ad request. For example, and furthering the above scenario, if an unidentified user visits CNN.com, then the estimation module will estimate (based on prior server-log data) that the visitor will experience fifteen impressions per hour. If one of the bidders 126 (through one of the publishers 120, 122 or 124) needs or desires to cap the impression frequency to approximately five impressions per hour, then the bidder will know to throttle bid submissions to 30%. Throttling the bid submissions effectively caps the frequency of bid submissions, which effectively caps the number of winning bids and ultimately caps the number of items of directed content or advertisements delivered to the visitor by a particular publisher, e.g., publisher 120.

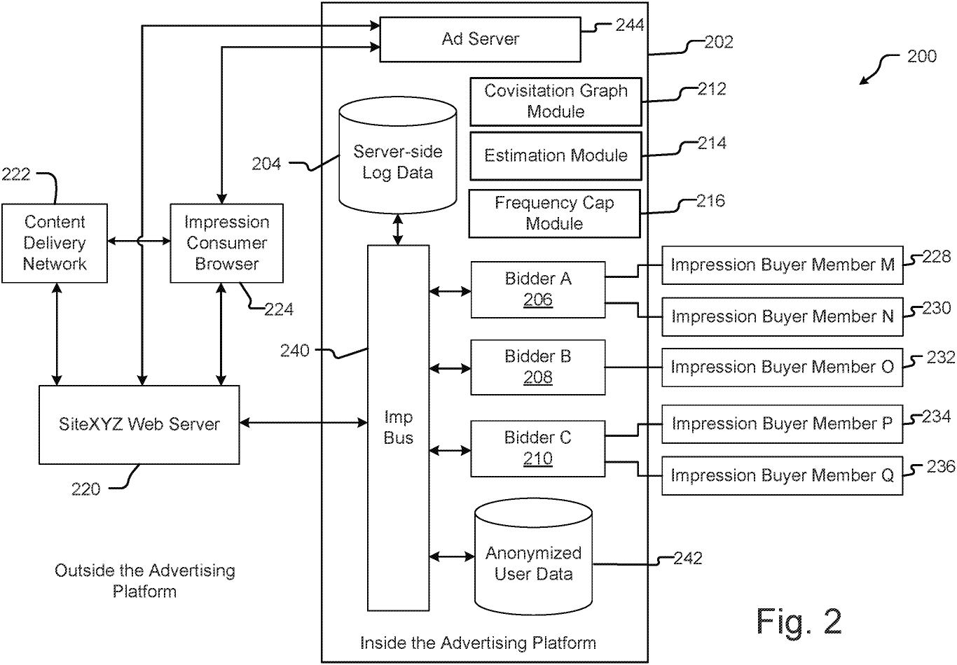

FIG. 2 shows another exemplary embodiment of an advertising environment 200 that may be implemented in accordance with aspects of the present disclosure. As shown, advertising platform 202 may comprise server-side log data 204, which, in embodiments, is similar to server log data 128 shown and described above in conjunction with FIG. 1. Advertising platform 202 may further comprise separate bidders, such as bidder A 206, bidder B, 208 and bidder C 210, which correspond to bidders 126 of FIG. 1. Advertising platform 202 may further comprise covisitation graph module 212, estimation module 214, and frequency cap module 216 which effectively correspond to the discussion above of covisitation graph module 130, estimation module 132, and frequency cap module 134 in conjunction with FIG. 1.

Advertising platform 202, as shown in FIG. 2, operates in conjunction with external components including an exemplary web server 220 which, as shown, implements a web site designated SiteXYZ. Advertising platform further operates in conjunction with a content delivery network 222, a browser 224 of an impression consumer, and a plurality of impression buyer computer systems. The plurality of impression buyer computer systems comprise a system for impression buyer member 228 associated with impression buyer member M, a system for impression buyer member 230 associated with impression buyer member N, a system for impression buyer member 232 associated with impression buyer member O, a system for impression buyer member 234 associated with impression buyer member P, and a system for impression buyer member 236 associated with impression buyer member Q.

The advertising platform 202 may also include an Imp Bus 240, an anonymized server-side user data store 242, and an ad server 244. The Imp Bus 240 is considered a transaction management computing subsystem that, in embodiments, operates as a central control point of the advertising platform 202. The Imp Bus 240 receives ad requests and/or other impression purchase opportunities from sources outside the advertising platform 202, such as from SiteXYZ web server 220. The Imp Bus 240 generates a bid request and communicates the bid request to each bidder 206, 208, 210 within the advertising platform 202. In response, the Imp Bus 240 receives one or more real-time bid responses on behalf of one or more impression buyer members 228, 230, 232, 234 236 through bidders 248, 250, 252 based on their respective associations. The Imp Bus 240 identifies a winning bid from among the bid responses returned by the bidders 206, 208 and 210 and returns a URL that identifies a location of a creative of the winning bid to the SiteXYZ web server 220, where a creative is an advertisement or other item of directed content.

In exemplary embodiments, a bid request is generated by the Imp Bus 240 and that does not include information that otherwise characterizes the impression consumer or user. In the past, such bid requests may have included such characterization information, where the information may have included such details as age, gender, income, race information, geographic, psychographic and/or behavioral information for the user. Prior implementations used third-party technology to store such information. In embodiments of the advertising platform 202, some anonymized user data may be stored in store 242 which may relate to device identification values or the like. Such information may be used, in some embodiments, to assist in creating covisitation graphs as discussed below.

In embodiments, the bid request includes information about the impression or ad space associated with a platform-specific ad tag. In other embodiments, a bid request provided by the Imp Bus 240 to the bidders 206, 208 and 210 may further include the following information:

a. Members: If included, a bidder may only consider the campaigns and items of directed content associated with impression buyer members having identifiers included in a Members array of information about identifiers for impression buyer members.

b. Frequency: The total number of impressions for this user across the advertising platform 202, if known by IP address or some other anonymized identifier.

c. Clicks: The total number of clicks for this user across the advertising platform 202, if known, if known by IP address or some other anonymized identifier.

d. Recency: The number of minutes since the last impression for this user across the advertising platform 202, if known by IP address or some other anonymized identifier.

e. Session Frequency: The number of impressions in a current session for this user, if known by IP address or some other anonymized identifier.

f. Estimated Winning Bid Price: The price estimated to win the bid, based on predetermined and/or historical criteria.

A bid request can include all of this information, any combination of this information or additional information as well.

The SiteXYZ web server 220 interacts with the content delivery network 222 and the browser 224 of the impression consumer, (also referred to as the user or site visitor) to receive and provide information. For example, the SiteXYZ web server 220 may receive a request for a web page from the content delivery network 222, the web browser 224, or both. In return, the SiteXYZ web server 220 provides the requested web page and other data to the content delivery network 222, the web browser 224, or both.

The impression consumer’s web browser 224 may operate in conjunction with user equipment such as a mobile device, cellular or wireless telephone, tablet computer, laptop or desktop computer, or any other equipment that can instantiate a web browser or provide access over a network to remote equipment such as the content delivery network 222, the SiteXYZ web server 220, and the ad server 244. The impression consumer web browser 224 may include a client-side user data store, not shown. The client-side user data store stores data locally, on the device of the web browser 224 or in conjunction with the web browser 224.

Each bidder 206, 208 and 210 receives bid requests from the Imp Bus 240 in response to an impression or other advertising placement opportunity received at the advertising platform 202. The bid request includes information about the impression and invites the bidders 206, 208 and 210, on behalf of one or more of the plurality of impression buyers 228, 230, 232, 234 and 236, to develop a bid to respond to the bid request. The response is in the form of a bid response provided to the Imp Bus 240. In some embodiments, a bid response includes information identifying, for example, a bid price and an item of directed content that is to be served should the bid be identified as the winning bid of a platform-based auction.

The actual creative may be supplied or, in the alternative, information identifying the creative or providing a location such as a URL or other network location where the creative can be found and retrieved. In other exemplary embodiments, a bid response provided by a bidder 206, 208 and 210 to the Imp Bus 240 may further include the following information:

a. Member ID: This may be an identifier of the impression buyer member whose creative is chosen by the bidder 206, 208 and 210 from a “Members” array of identifiers in the bid request.

b. No bid: This flag, which may have exemplary value of yes or no, may indicate to the Imp Bus 240 that the bidder has returned a valid response but has chosen not to bid.

c. Price: The price, expressed as a cost per mille or thousand impressions (CPM), that the bidder is willing to pay for this impression. If exclusive, this is used only for reporting purposes; if not exclusive, this value may represent a reserve set by the bidder.

d. Creative ID: Identification or location information of the item of directed content and/or advertising creative to be served if the bid response is selected as the winning bid.

A bid response can include all of this information, any combination of this information or additional information as well, as will be appreciated by those skilled in the art.

The advertising platform 202 conducts an auction using bids to decide which ad creative will fill an ad call identifying an impression to be filled. The bid responses provided by the bidders 206, 208 and 210 compete in an auction to determine which bid request is selected by the Imp Bus 240 for providing the item of directed content in response to the impression or other advertising placement opportunity. The item of directed content, or related information, is provided, for example, to the SiteXYZ web server 220. In some embodiments, information about the item of directed content selected in the auction by the Imp Bus 240 is used by the SiteXYZ web server 220 to directly access the item in the ad server 244.

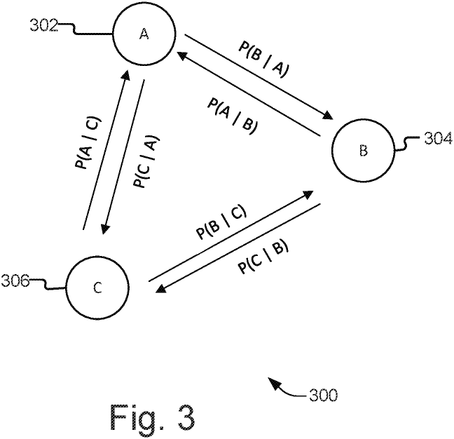

FIG. 3 is a block diagram illustrating an example, non-limiting embodiment of a covisitation graph 300 implemented or modeled by a system functioning within the communication network of FIG. 1 in accordance with various aspects described herein. The covisitation graph 300 in this example includes three nodes (e.g., three websites), labelled node A 302, node B 304 and node C 306. Each respective node is characterized by a probability that a user that visited that node also visited the other nodes. Thus node B 304 has a probability P(B | A) of being a visitor of node B 304 and a visitor of node A 302, and a probability P(B | A) of being a visitor of node B 304 and a visitor of node C 306. Node A 302 and Node C 306 have similar corresponding probabilities. The covisitation graph 300 therefore represents an estimate of user behavior among a set of related websites that the user might visit. The covisitation graph 300 enables enforcement of frequency capping in ad advertising platform without using cookies through the understanding of these covisitation probabilities, as discussed below. Although shown as a graph, the covisitation graph 300 may be depicted as a matrix, or a table or any other known method of identifying relationships between entities, such as websites, along with the probability of covisitation.

In embodiments, the probabilities may be estimated based on, for example, server logs and other data collected by the advertising platform, such as advertising platforms 118 and/or 202 shown and described above. That is, during operation of an advertising platform, the advertising platform collects information, based on IP addresses and/or other universal third-party identifiers as to visitation activity of a sample of users. Those skilled in the art will appreciate that other identification information may be used as a proxy for identifying a user, and that such information can be anonymized.

In embodiments, the probability for a visitor to website A to be a visitor to website B, which is represented as P(B | A), may be estimated as:

$$\begin{matrix}\text{P} \left(\text{B} \left|\text{A}\right)\right) = \\ \left(\# o f d i s t i n c t i d s s e e n o n B a n d A\right) / \left(\# o f d i s t i n c t i d s s e e n o n A\right)\end{matrix}$$

Similarly, P(B | C), P(A | B), P(A | C), P(C | A) P(C | B) can be estimated using similar equations. The number of distinct ids is the number of unique individuals that can be identified based on a cookie, if available, or based on some proxy such as IP address, email address, or other information. The number of distinct ids or identifiers of visitors to a website represents a sample of all visitors to each website. That is, the number represents a sample since it is anticipated that not all visitors to each website can be tracked or monitored because identification information is not available for all visitors. However, using such a sample of visitors provides a high degree of confidence in the model of the system and method.

Although the graph 300 may be created based on samples of actual visitors to sites, other methods of relating sites are contemplated. That is sites may be considered related based on any suitable parameter. For example, sites which are related to “topical news” such as, CNN.com, BBC.com and NYTIMES.com may be considered related and tests may be evaluated to determine the probability of covisitation based on this parameter.

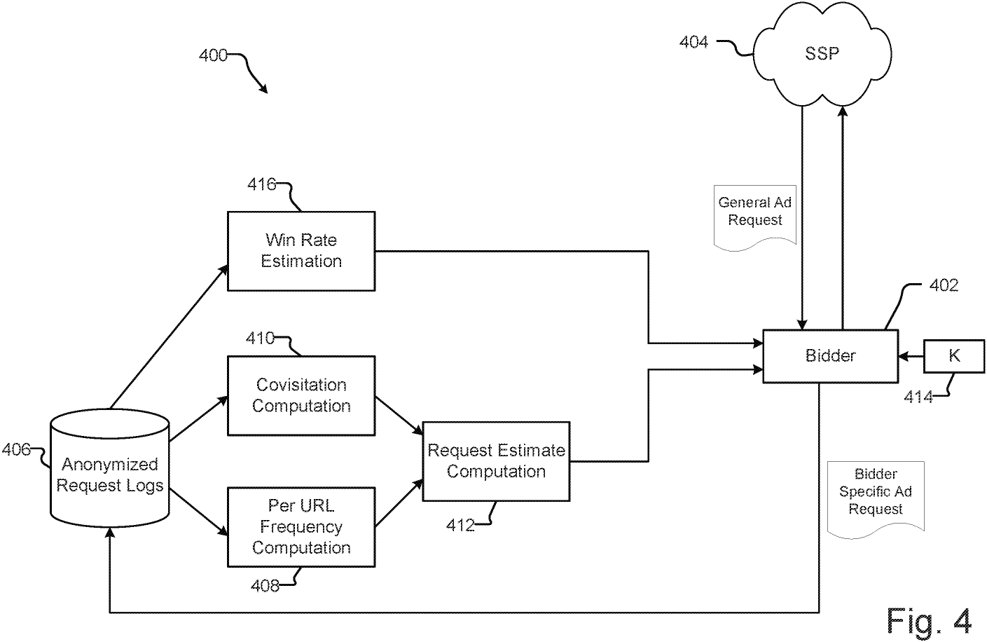

FIG. 4 depicts an illustrative embodiment of a functional block diagram for enforcing probabilistic frequency capping in an advertising platform environment 400 in accordance with various aspects described herein. The functional block diagram is exemplary only and intended to illustrate some aspects of the system and method described herein.

As part of the advertising platform 400, a bidder 402 receives a general request for directed content, also referred to herein as an ad request, from a supply side platform 404. The supply side platform 404 may be within the advertising platform 400 (such as from Imp Bus 240 shown in FIG. 2) or outside the advertising platform 400 such as from websites when visited by a user, (e.g., website 110 shown in FIG. 1). Either way, the supply side platform 404 is meant to show the sending of general directed content or ad requests, to bidder 402 in order to alert the bidder 402 that an impression is available to be bid on.

The bidder 402 communicates the bid request, along with some bidder specific information to a database or other storage 406 which stores anonymized request logs of directed content requests and/or ad requests. Accordingly, the request log information includes historical data about requests that have been previously received by a bidder 402 interacting with a supply side platform 404 for delivering directed content or advertisements to websites to fill impressions for visitors to the websites. The bidder 402 may, in embodiments, correspond to any of the plurality of bidders including bidder A 206, bidder B 208 and bidder C 210 shown and described above in conjunction with FIG. 2, for example.

The information stored in the anonymized request logs 406 is used by a per URL frequency computation function 408 to compute frequency values for each website, such as any website associated with an ad request. The frequency values computed at function 408 correspond to the expected number of impressions seen on each website including a website for visitors of that website. In embodiments, the computation process occurring at block 408 determines the average number of impressions per user, per website. This may be determined by a simple query to the anonymized request logs 406.

In other embodiments, the per URL frequency computation function 408 provides results represented as E[Nx | X], which represents the expected number of impressions seen on website X for visitors of website X, estimated from available historical data for example. In practice, E[Nx | X] may be estimated as a ratio:

$$\begin{matrix}\text{E} \left({\text{N}}_{\text{X}} \left|\text{X}\right)\right) = \\ \left(\# o f i m p r e s s i o n s s e e n o n X\right) / \left(\# o f d i s t i n c t i d s s e e n o n X\right)\end{matrix}$$

The denominator, that is, the number of distinct identities or user identifiers seen on website X may be estimated using a sample of information based on visitors that visit the website X having distinct identifiers. The function 408 may generate and store related estimate information for a plurality of websites and/or update the estimates as needed.

The information stored in the anonymized request logs 406 is also used by the covisitation computation function 410 to compute a covisitation graph such as the covisitation graph 300 illustrated in FIG. 3. As stated above, the covisitation computation identifies a sample of identified users, such as users whose identity is known based on IP addresses or other information. In some embodiments, the covisitation computation function 410 groups the users into sets for each website. In such a case, the sets may be used to determine probabilities for the covisitation graph based on different criteria, such as dwell time or some other criteria. The data determined by the process 410 corresponds to path data for the covisitation graph. It is anticipated that the covisitation graph will include dozens or hundreds of nodes.

In an embodiment, request estimate computation function 412 aggregates results from the per URL frequencies computation function 408 and the covisitation computation function 410. Function 412 further computes final estimates which are used for computation of delivery rates. The results of the function 412 are provided to the bidder 402.

In an example, where E[Na | A] is the expected number of impressions seen on website A for visitors of website A, and as discussed above, E[N_{A} | A] may be estimated as a ratio:

$$\begin{matrix}\text{E} \left({\text{N}}_{\text{A}} \left|\text{A}\right)\right) = \\ \left(\# o f i m p r e s s i o n s s e e n o n A\right) / \left(\# o f d i s t i n c t i d s s e e n o n A\right)\end{matrix}$$

Then function 412 may use this information, with the probability information from covisitation computation function 410, such as P(B | A) described above to estimate the expected number of impressions seen on website B for a user behind a bid request on website A, which is represented as E[N_{B} | A] and is calculated according the following formula:

$$\text{E} \left[{\text{N}}_{\text{B}} \left|\text{A}\right)\right] = \text{E} \left[{\text{N}}_{\text{B}} \left|\text{B}\right)\right] \times \text{P} \left(\text{B} \left|\text{A}\right)\right)$$

Consequently E[N_{B} | A] represents an estimate of the number of impressions for a visitor on the website B knowing the user has been a visitor of website A. As will be appreciated, E[N_{B} | B] corresponds to an average number of impressions seen on website B. Again, P(B | A) corresponds to the probability of being a visitor on website B from the covisitation graph. Such data is used to estimate the average number of impressions seen by a visitor per inventory object, where, in embodiments, an inventory object corresponds to a website.

With respect to the exemplary graph 300 shown and described in conjunction with FIG. 3, the system and method implemented by a processing system of an advertising platform 400 estimates the expected total number of impressions seen on website A, website B and website C in the example covisitation graph 300 as:

$$\begin{matrix}\text{E} \left[\text{N} \left|\text{A}\right)\right] = \text{E} \left[{\text{N}}_{\text{A}} \left|\text{A}\right)\right] + \\ \left(\text{E} \left[{\text{N}}_{\text{B}} \left|\text{B}\right)\right] \times \text{P} \left(\text{B} \left|\text{A}\right)\right)\right) + \left(\text{E} \left[{\text{N}}_{\text{C}} \left|\text{C}\right)\right] \times \text{P} \left(\text{C} \left|\text{A}\right)\right)\right)\end{matrix}$$

The value E[N | A] represents the estimated number of impressions seen, over the full set of possible websites that the user might visit, according to the probabilities of the covisitation graph. The estimated value may then be passed to the bidder 402.

The bidder 402 also receives a frequency cap value, K. The frequency cap value K may be received by the bidder 402 many different ways. FIG. 4 shows the functional aspect via block 414. The function 414 may correspond to a database of stored publisher information or a user interface accessible by the publisher of the directed content to specify the frequency cap value K for each advertisement, campaign, or other item(s) of directed content.

The bidder 402, using the request estimates from the process 412 and the frequency cap value from the process 414, determines a delivery rate p. The delivery rate p relates to the rate at which impressions or advertisements will be provided to a user, over a specified time period. In examples, the delivery rate may equal, for a predetermined period of time, the frequency cap value divided by the total number of estimated impression views. For instance, if a user is estimated to view ten impressions over the course of an hour, based on the results of computation 412, and the frequency cap is set at three items of directed content per hour, then the delivery rate p can be set at 30%. Consequently, bidder 402 will, in embodiments, bid on 30% of the ad requests.

With respect to certain aspects of other embodiments, the delivery rate p may be dynamically corrected based on other information such as information related win rate estimation function 416. In such embodiments, dynamic correction is to account for the fact that, when the bidder 402 places a bid, it is not guaranteed that the bid will be won. Accordingly, the delivery rate will be adjusted based on the information from the win rate estimation function 416. Generally, any correction will cause an increase to the delivery rate. For example, if the bidder 402 is intends to deliver directed content to one-third of the opportunities based on the frequency cap, but the bidder is winning only one-half of the auctions, the delivery rate must be increased to capture the difference, e.g., the frequency may be doubled in this example to achieve a bid win rate of approximately 30% of the auctions.

Accordingly, estimation function 416 determines information about how often the bidder determines a successful bid, or a bid that wins an auction to fill an impression on a website visited by a user. The win rate estimation process 416 corresponds to a feedback of all the processes that happen in the bidder 402 in deciding whether to bid on an auction or not. Those processes are independent of the frequency capping process. Supplying information from the win rate estimation process 416 serves to compensate for those other processes.

Different benefits are achieved through the process shown and described in conjunction with FIG. 4. For instance, given that the delivery rate has been calculated, the backend processing can be simplified in that information on each specific user need not be tracked.

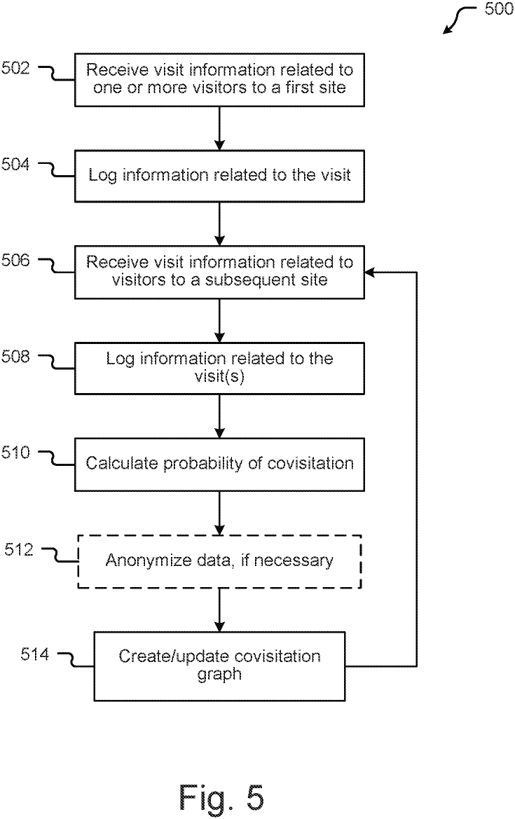

FIG. 5 is a flow chart illustrating a method 500 for creating and/or updating covisitation graph, such as covisitation graph 300 shown and described above in conjunction with FIG. 3. A general order of the operations for the method 500 is shown in FIG. 5. While a number of operations are shown, the method 500 may include more or fewer steps or may arrange the order of the steps differently than those shown in FIG. 5. The method 500 can be executed as computer-executable instructions executed by a computer system and encoded or stored on a computer readable medium. Further, the method 500 can be performed by gates or circuits associated with a processor, an ASIC, an FPGA, a SOC or other hardware device. Hereinafter, the method 500 shall be explained with reference to the systems, components, devices, modules, software, data structures, data characteristic representations, signaling diagrams, methods, etc., described in conjunction with other figures described herein.

Method 500 generally begins with receive operation 502, wherein visit information related to one or more visitors to a first site is received. The method 500 of creating a covisitation graph receives the information related to visitors to sites to start building relationship information between such sites. As discussed above, the information received may be in the form of one or more ad requests for the site, wherein the requests will include the URL and some information related to the user or device generating the ad request.

Next, at log operation 504, the method 500 logs the received information related to the visit to the first sight.

Receive operation 506 represents the receipt of other, related visit information associated with one or more related sites, which is then logged at log operation 508. In accordance with embodiments, the receive operation 506 relates to information received from the same user associated with the visit information logged at log operation 504. In essence, when a user browses or links from one website to another, using the same IP address, the method 500 logs that information.

Upon collecting enough information, calculate operation 510 calculates the probability values between different sites. As discussed above in conjunction with FIG. 3, calculating the probabilities may involve dividing the number of distinct id values, which may be estimated as representing distinct users, on two related sites by the number of distinct ids on one of the sites. As stated above, for example, the probability for a visitor to website A to be a visitor to website B, which is represented as P(B | A), may be estimated as:

$$\begin{matrix}\text{P} \left(\text{B} \left|\text{A}\right)\right) = \\ \left(\# o f d i s t i n c t i d s s e e n o n B a n d A\right) / \left(\# o f d i s t i n c t i d s s e e n o n A\right)\end{matrix}$$

An optional step of anonymizing the data 512 is shown for situations where the method is able to track a particular user for various reasons based on identifiable information, such as through the use of first party cookie information, or wherein the user has logged into particular system or otherwise opted into such tracking system. As a result, operation 512 may anonymize the data, e.g., delete or disregard the data. In essence, the probability information becomes data that does not contain any user-identifiable characteristics, but instead the probability data is just a value or probability that any visitor will visit a second site upon visiting a first site.

Using the probability data, operation 514 creates or updates the covisitation graph. Operation 514 essentially maintains the graph, such as the graph 300 shown in FIG. 3. As stated above, the graph may be stored in multiple different forms, such as a graph, a matrix, a table, etc.

Next, flow branches back to operation 506 to receive more site visit information related to visitors to subsequent sites. The flow back to operation 506 is meant to indicate that the method may continue to receive new information and the probabilities of covisitation between sites may therefore continue to be logged and updated.

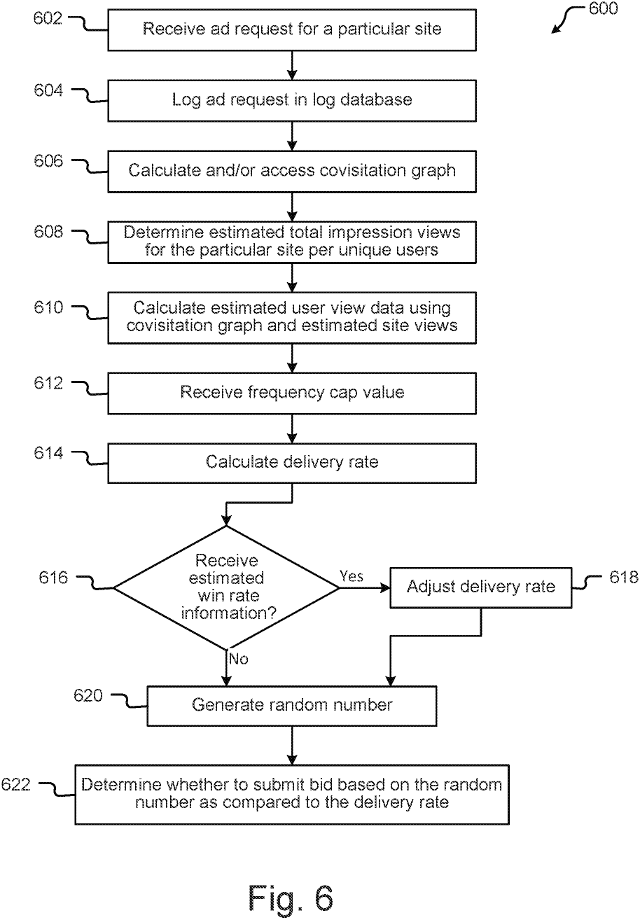

FIG. 6 is a flow chart illustrating a method 600 for enforcing probabilistic frequency capping. A general order of the operations for the method 600 is shown in FIG. 6. While a number of operations are shown, the method 600 may include more or fewer steps or may arrange the order of the steps differently than those shown in FIG. 6. The method 600 can be executed as computer-executable instructions executed by a computer system and encoded or stored on a computer readable medium. Further, the method 600 can be performed by gates or circuits associated with a processor, an ASIC, an FPGA, a SOC or other hardware device. Hereinafter, the method 500 shall be explained with reference to the systems, components, devices, modules, software, data structures, data characteristic representations, signaling diagrams, methods, etc., described in conjunction with other figures described herein.

As shown in FIG. 6, the method 600 generally begins with receive operation 602 wherein an ad request is received, such as by a bidder or more generally by an application platform. While shown as an ad request, those skilled in the art will appreciate that the ad request may relate to any directed content request in accordance with aspects of this disclosure. The ad request contains at least some specific information such as the website or URL information associated with the request. Additionally, the ad request, in embodiments, contains some user-based information such as an IP address or a device identifier for the current user or visitor of the website. That said however, in other embodiments, the ad request may not contain any user-based information.

Following receive ad request operation 602, method 600 may log the request in a log database. In embodiments, log operation allows for the recordation of user activity such that future analysis may have the benefit of such logged information. Log ad request information 604 is, in embodiments, similar to the log operations shown and described above in conjunction with FIG. 5.

Next, in embodiments, calculate and/or access covisitation graph 606 may calculate the probabilities of covisitation for visitors of different sites based on ad request or other information. As one skilled in the art will appreciate, calculate operation 606 may be functionally similar to flow 500 shown and described above with respect to FIG. 5. Moreover, it will be appreciated by one skilled in the art that calculate covisitation graph step 606 may, in embodiments, relate to simply maintaining the graph. That is, the graph, over time, may simply be accessed on a regular basis and then updated periodically.

Next, in embodiments, determine operation 608 determines the estimated total views for the particular site. As stated, the ad request has information related to the site (or URL) having the impression to be filled. The log database also maintains information as to the number of visits to that site. The log database, as discussed above, also maintains information related to each of those visits as to whether the visits are based on unique identifiers, thereby implying unique individuals or users. From this information, a value can be determined as to the estimated total site visits. As will be appreciated, some visit information may not have associated unique identifying information such that that information may not be included in the determination operation 608.

Also, operation 608 also evaluates historical log data to determine the number of impression views for each user on the particular site. In embodiments, the log data can store each different ad request for a given site, and for a given user over a determined period of time. Alternatively, operation 608 may simply increment a value related to each known visit when an ad request is received to maintain a total number of visits to a site. In embodiments, the total number of visits to a site may use only the ad request information that includes unique user information such that future estimates are based on samples with some user-based distinguishing information. That is, while the information does not actually identify a specific user, it is more helpful to understand whether the ad requests are coming from the same user, e.g., a device with the same IP address as compared to different users, e.g., devices with different IP addresses.

Using the information related to the estimated number of total unique visitors to a particular site and the aggregated total number of views an estimate can be determined for the total views for the particular site. From this data, operation 608 estimates the total number of views, thereby implying the total number for each user.

Following determine operation 608, calculate operation 610 calculates or estimates user view data for the user behind the initial ad request. Calculate operation 610 uses the values from operations 606 and 608 to determine an estimate of the number impressions a user behind the ad request will likely see, based on the understanding that past users viewed a certain number of impressions on that particular site plus the number of impressions viewed on related sites. In essence, when a user visits a site and that site triggers an ad request indicating its particular URL, then flow 600 is able to estimate the total number of potential views that user will experience across a plurality of sites. In embodiments, the estimated user view data will equal the estimated total number impressions value determined in operation 606 plus the estimated number of views on related sites identified in the covisitation graph multiplied by the probability that the user will visit the related sites, also indicated in the covisitation graph.

Receive operation 612 receives the requested value for the frequency cap. This value may be received at any point prior to calculating the delivery rate and may be established in a number of different ways. In embodiments, since the publisher is bidding on impression behind the ad request, then the publisher typically sets the cap value. For example, a publisher of directed content or ad may want to cap the number of views of that item over a predetermined period of time. For example, a publisher may want to cap the number of times a user sees an ad to three per hour. Alternatively, the publisher may want to cap the number of views per product or other campaign. In yet other embodiments, the bidder may operate on behalf of multiple publishers and enforces set frequency cap values on behalf of the publishers as part of an agreement between the publisher and the bidder. As will be appreciated, receive operation 612 may be accomplished in various ways, such as requesting the value from the publisher and receiving it in response, or simply looking up the previously stored value.

Using the frequency cap value from step 612 and the calculated estimate from operation 610, calculate delivery rate operation 614 then calculates the actual delivery rate the bidder will use to determine whether to bid on the ad request or not. In embodiments, calculate delivery rate operation divides the frequency cap value by the number of estimated views determined at operation 610 to establish the delivery rate. For example, if the desired frequency cap value is previously established to be three views per hour and the estimated number of views for the unidentified user behind the specific ad request is ten views per hour, then the frequency rate may be set as three divided by ten, or 30%. In embodiments, this value is then used by the bidder to throttle the bid requests to only bid on 30% of the ad requests for that site.

Next, in some embodiments, an additional determination may be made at decision 616 regarding whether win rate information is available. If the bidder receives past win rate information, then flow branches Yes to adjust delivery rate option 618 which adjusts the delivery rate in view of the win rate information. As discussed above in conjunction with function 416 shown in FIG. 4, the delivery rate may be dynamically corrected based on other information such as information related win rate estimation function 416 to account for the fact that not all bids are won. Accordingly, the delivery rate may be adjusted based on the information from the known win rate information at operation 618.

Next, generate random number operation 620 may be used to enforce the calculated delivery rate from operation 614 or the adjusted delivery rate from operation 618. In essence, once the ultimate delivery rate is determined, the bidder must throttle the bid requests as described below.

Using the random number generated from operation 620, flow 600 determines whether to bid on the ad request or to suppress the bid. In one embodiment, a random number can be generated (at operation 620) between 1 and 100 and if the random number is above the frequency rate value then the bid is suppressed and if the random number is below the frequency rate value then the bid is submitted. For example, if the determined, frequency capped delivery rate is 30%, then the bid will be submitted if the random number is 30 or less. Alternatively, the bid will be suppressed or rejected if the random number is 31 or higher. While not guaranteed to be exact, over time, this process will cause the bidder to submit bids approximately 30% of the time for a given site. Those skilled in the art will appreciate that other methods other than using a random number generator may be used to effectively throttle bids to the desired delivery rate. Once the bid is submitted or suppressed, then the flow 600 ends.

Turning now to a specific example, assume a publisher or other advertiser wants an advertising platform to deliver at most K ads to each user, where K is a frequency capping value specified by the publisher for the particular ad. The advertising platform may determine an estimate E[N| A] of the average number of impressions seen on website A, website B, and website C for a user behind a single bid request originating from website A. As discussed above this value may be determined using the following formula:

$$\begin{matrix}\text{E} \left[\text{N} \left|\text{A}\right)\right] = \text{E} \left[{\text{N}}_{\text{A}} \left|\text{A}\right)\right] + \\ \left(\text{E} \left[{\text{N}}_{\text{B}} \left|\text{B}\right)\right] \times \text{P} \left(\text{B} \left|\text{A}\right)\right)\right) + \left(\text{E} \left[{\text{N}}_{\text{C}} \left|\text{C}\right)\right] \times \text{P} \left(\text{C} \left|\text{A}\right)\right)\right)\end{matrix}$$

From historical data, in this specific example, the advertising platform may determine the average number of impressions seen on each site are as follows:

$$\text{E} \left[{\text{N}}_{\text{A}} \left|\text{A}\right)\right] = 5 , \text{E} \left[{\text{N}}_{\text{B}} \left|\text{B}\right)\right] = 6 , \text{and E} \left[{\text{N}}_{\text{C}} \left|\text{C}\right)\right] = 8$$

Thus, based on log data in this example, the advertising platform determines that on website A there are 5 opportunities to display the ad, on website B there are 6 opportunities to display the ad and on website C there are 8 opportunities to display the ad. From log data and the covisitation graph, the advertising platform further knows that the probabilities of a user being a visitor of website B and website C, knowing the user is a visitor of A are

$$\text{P} \left(\text{B} \left|\text{A}\right)\right) = 0.5 \text{and P} \left(\text{C} \left|\text{A}\right)\right) = 0.25$$

Then, the expected number of impressions seen is given as

$$\text{E} \left[\text{N} \left|\text{A}\right)\right] = 5 + \left(6 \times 0.5\right) + \left(8 \times 0.25\right) = 10$$

That is, the expected number of impressions seen is: 5, or the expected value for website A; plus 6, the expected value for website B times the probability of being a visitor of website B or 0.5; plus 8, or the expected value for website C times the probability of being a visitor of website C, or 0.25, for a total of 10. Accordingly, the value related to the estimated total number of opportunities to display an ad to a user is 10 for the predetermined time period.

The advertising platform may throttle the delivery rate so that only p impressions are delivered where p is calculated as:

$$\text{p} \text{=} \frac{\text{K}}{\text{E} \left[\text{N} \left|\text{A}\right)\right]}$$

Using this formula, the advertising platform will deliver K impressions of the ad per user, on average. As discussed above, this rate may be enforced with a random number generator or other device. In this specific example, if the frequency cap, or the total number of impressions or opportunities to see the ad specified by the advertiser is set to 3 impressions for a predetermine period of time, then the rate of delivery should then be

$$p = \frac{3}{10} = 30 \%$$

The advertising then randomly selects a number between 1 and 100 (sometimes thought of as functionally rolling a 100-sided dice). If the result is below 30, in this example, the advertising platform submits the bid. Alternatively, if the random number is greater than 30 then the advertising platform does not submit the bid.

As will be appreciated, the capping decision is based on a single bid request, which is the only piece of information about the user available at the time the bid request is received. The systems and methods described herein do not require user-identifying information in determining whether to submit or suppress the bid.

A number of benefits are provided by the system and method in accordance with various aspects described herein. By expanding frequency capping products to identity-less users, the proposed solution enables a directed content network operator to continue meeting advertisers’ needs in the future id-less advertising ecosystem. Further, the system and method valorize id-less traffic by providing more control over such traffic, making such traffic more appealing to advertisers. Further, the system and method improve reach through valorized id-less traffic, where reach is the number of unique users exposed to a particular advertisement. Still further, the system and method are privacy-aware. Data from individual users are anonymized. Moreover, data that are processed are aggregated so data from individual users is not considered. No personal identifiers are used in the system and method.

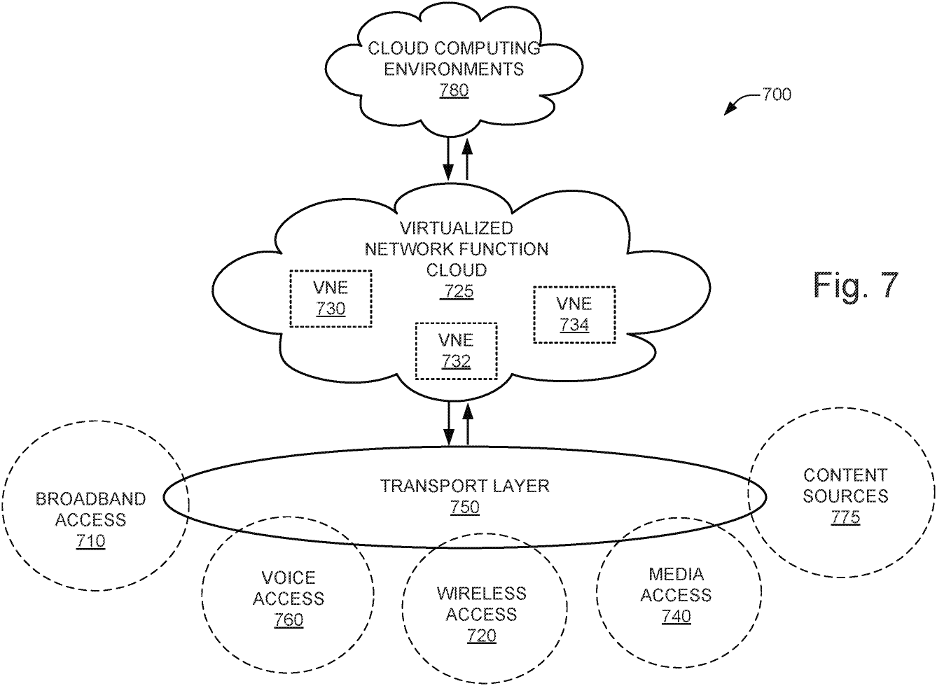

Referring now to FIG. 7, a block diagram 700 is shown illustrating an example, non-limiting embodiment of a virtualized communication network in accordance with various aspects described herein. In particular a virtualized communication network is presented that can be used to implement some or all of the subsystems and functions of the system 100, the subsystems and functions of systems, and methods presented in FIGS. 1-6. For example, virtualized communication network 700 can facilitate in whole or in part an online content delivery system and method which conducts an auction among bids to serve a directed content to a web page to fill an impression and implement a frequency capping process, even in the absence of identification information such as browser cookies for users.

In particular, a cloud networking architecture is shown that leverages cloud technologies and supports rapid innovation and scalability via a transport layer 750, a virtualized network function cloud 725 and/or one or more cloud computing environments 780. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 730, 732, 734, etc. that perform some or all of the functions of network elements 750, 752, 754, 756, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general purpose integrated circuit devices offered by merchants (referred to herein as merchant silicon) are not appropriate. In this case, communication services can be implemented as cloud-centric workloads.

As an example, a traditional type of network elements, such as an edge router can be implemented via a VNE 730 composed of NFV software modules, merchant silicon, and associated controllers. The software can be written so that increasing workload consumes incremental resources from a common resource pool, and moreover so that it’s elastic: so the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 750 includes fiber, cable, wired and/or wireless transport elements, network elements and interfaces to provide broadband access 710, wireless access 720, voice access 760, media access 740 and/or access to content sources 775 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front-ends (AFEs) that do not lend themselves to implementation as VNEs 730, 732 or 734. These network elements can be included in transport layer 350.

The virtualized network function cloud 725 interfaces with the transport layer 750 to provide the VNEs 730, 732, 734, etc. to provide specific NFVs. In particular, the virtualized network function cloud 725 leverages cloud operations, applications, and architectures to support networking workloads. The virtual network elements 730, 732 and 734 can employ network function software that provides either a one-for-one mapping of traditional network element function or alternately some combination of network functions designed for cloud computing. For example, VNEs 730, 732 and 734 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and overall which creates an elastic function with higher availability than its former monolithic version. These virtual network elements 730, 732, 734, etc. can be instantiated and managed using an orchestration approach similar to those used in cloud compute services.

The cloud computing environments 780 can interface with the virtualized network function cloud 725 via APIs that expose functional capabilities of the VNEs 730, 732, 734, etc. to provide the flexible and expanded capabilities to the virtualized network function cloud 725. In particular, network workloads may have applications distributed across the virtualized network function cloud 725 and cloud computing environment 780 and in the commercial cloud or might simply orchestrate workloads supported entirely in NFV infrastructure from these third-party locations.

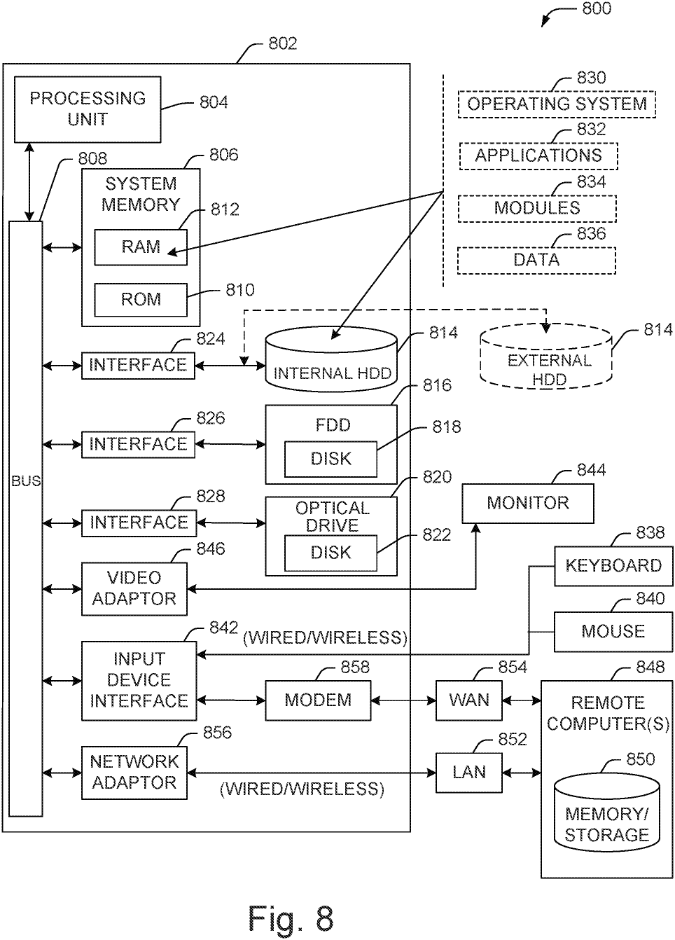

Turning now to FIG. 8, there is illustrated a block diagram of a computing environment in accordance with various aspects described herein. In order to provide additional context for various embodiments of the embodiments described herein, FIG. 8 and the following discussion are intended to provide a brief, general description of a suitable computing environment 800 in which the various embodiments of the subject disclosure can be implemented. In particular, computing environment 800 can be used in the implementation of network elements such as VNEs 730, 732, 734, etc. as shown in FIG. 7. Each of these devices can be implemented via computer-executable instructions that can run on one or more computers, and/or in combination with other program modules and/or as a combination of hardware and software. For example, computing environment 800 can facilitate in whole or in part an online content delivery system and method which conducts an auction among bids to serve a directed content to a web page to fill an impression and implement a frequency capping process, even in the absence of identification information such as browser cookies for users.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 8, the example environment can comprise a computer 802, the computer 802 comprising a processing unit 804, a system memory 806 and a system bus 808. The system bus 808 couples system components including, but not limited to, the system memory 806 to the processing unit 804. The processing unit 804 can be any of various commercially available processors. Dual microprocessors and other multiprocessor architectures can also be employed as the processing unit 804.

The system bus 808 can be any of several types of bus structure that can further interconnect to a memory bus (with or without a memory controller), a peripheral bus, and a local bus using any of a variety of commercially available bus architectures. The system memory 806 comprises ROM 810 and RAM 812. A basic input/output system (BIOS) can be stored in a non-volatile memory such as ROM, erasable programmable read only memory (EPROM), EEPROM, which BIOS contains the basic routines that help to transfer information between elements within the computer 802, such as during startup. The RAM 812 can also comprise a high-speed RAM such as static RAM for caching data.

The computer 802 further comprises an internal hard disk drive (HDD) 814 (e.g., EIDE, SATA), which internal HDD 814 can also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The HDD 814, magnetic FDD 816 and optical disk drive 820 can be connected to the system bus 808 by a hard disk drive interface 824, a magnetic disk drive interface 826 and an optical drive interface 828, respectively. The hard disk drive interface 824 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 812, comprising an operating system 830, one or more application programs 832, other program modules 834 and program data 836. All or portions of the operating system, applications, modules, and/or data can also be cached in the RAM 812. The systems and methods described herein can be implemented utilizing various commercially available operating systems or combinations of operating systems.

A user can enter commands and information into the computer 802 through one or more wired/wireless input devices, e.g., a keyboard 838 and a pointing device, such as a mouse 840. Other input devices (not shown) can comprise a microphone, an infrared (IR) remote control, a joystick, a game pad, a stylus pen, touch screen or the like. These and other input devices are often connected to the processing unit 804 through an input device interface 842 that can be coupled to the system bus 808, but can be connected by other interfaces, such as a parallel port, an IEEE 1394 serial port, a game port, a universal serial bus (USB) port, an IR interface, etc.

A monitor 844 or other type of display device can be also connected to the system bus 808 via an interface, such as a video adapter 846. It will also be appreciated that in alternative embodiments, a monitor 844 can also be any display device (e.g., another computer having a display, a smart phone, a tablet computer, etc.) for receiving display information associated with computer 802 via any communication means, including via the Internet and cloud-based networks. In addition to the monitor 844, a computer typically comprises other peripheral output devices (not shown), such as speakers, printers, etc.

The computer 802 can operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically comprises many or all of the elements described relative to the computer 802, although, for purposes of brevity, only a remote memory/storage device 850 is illustrated. The logical connections depicted comprise wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which can connect to a global communications network, e.g., the Internet.

When used in a LAN networking environment, the computer 802 can be connected to the LAN 852 through a wired and/or wireless communication network interface or adapter 856. The adapter 856 can facilitate wired or wireless communication to the LAN 852, which can also comprise a wireless AP disposed thereon for communicating with the adapter 856.

When used in a WAN networking environment, the computer 802 can comprise a modem 858 or can be connected to a communications server on the WAN 854 or has other means for establishing communications over the WAN 854, such as by way of the Internet. The modem 858, which can be internal or external and a wired or wireless device, can be connected to the system bus 808 via the input device interface 842. In a networked environment, program modules depicted relative to the computer 802 or portions thereof, can be stored in the remote memory/storage device 850. It will be appreciated that the network connections shown are example and other means of establishing a communications link between the computers can be used.

The computer 802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

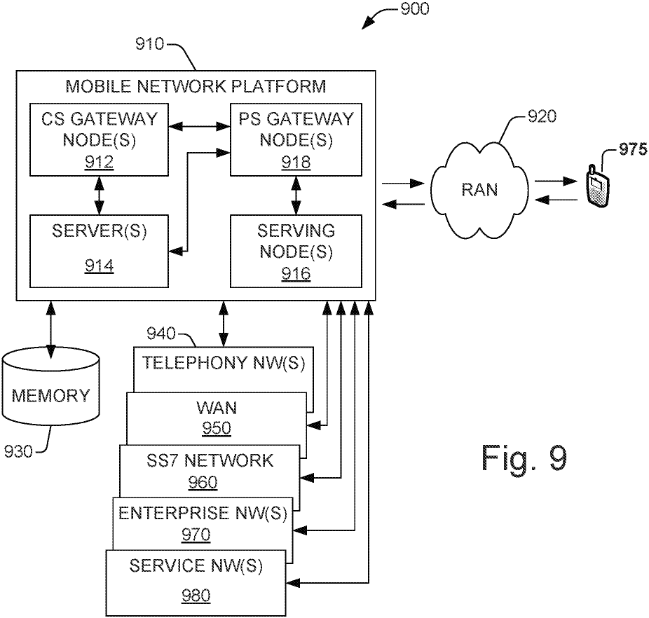

Turning now to FIG. 9, an embodiment of a communication device 900 of a mobile network platform 910 is shown that is an example of network elements such as VNEs 730, 732, 734, etc. For example, the mobile network platform 910 can facilitate in whole or in part an online content delivery system and method which conducts an auction among bids to serve a directed content to a web page to fill an impression and implement a frequency capping process, even in the absence of identification information such as browser cookies for users. In one or more embodiments, the mobile network platform 910 can generate and receive signals transmitted and received by base stations or access points such as base station or access point. Generally, mobile network platform 910 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 910 can be included in telecommunications carrier networks, and can be considered carrier-side components as discussed elsewhere herein. Mobile network platform 910 comprises CS gateway node(s) 912 which can interface CS traffic received from legacy networks like telephony network(s) 940 (e.g., public switched telephone network (PSTN), or public land mobile network (PLMN)) or a signaling system #7 (SS7) network 960. CS gateway node(s) 912 can authorize and authenticate traffic (e.g., voice) arising from such networks. Additionally, CS gateway node(s) 912 can access mobility, or roaming, data generated through SS7 network 960; for instance, mobility data stored in a visited location register (VLR), which can reside in memory 930. Moreover, CS gateway node(s) 912 interfaces CS-based traffic and signaling and PS gateway node(s) 918. As an example, in a 3GPP UMTS network, CS gateway node(s) 912 can be realized at least in part in gateway GPRS support node(s) (GGSN). It should be appreciated that functionality and specific operation of CS gateway node(s) 912, PS gateway node(s) 918, and serving node(s) 916, is provided and dictated by radio technology or technologies utilized by mobile network platform 910 for telecommunication over a radio access network 920 with other devices, such as a radiotelephone 975.

In addition to receiving and processing CS-switched traffic and signaling, PS gateway node(s) 918 can authorize and authenticate PS-based data sessions with served mobile devices. Data sessions can comprise traffic, or content(s), exchanged with networks external to the mobile network platform 910, like wide area network(s) (WANs) 950, enterprise network(s) 970, and service network(s) 980, which can be embodied in local area network(s) (LANs), can also be interfaced with mobile network platform 910 through PS gateway node(s) 918. It is to be noted that WANs 950 and enterprise network(s) 970 can embody, at least in part, a service network(s) like IP multimedia subsystem (IMS). Based on radio technology layer(s) available in technology resource(s) or radio access network 920, PS gateway node(s) 918 can generate packet data protocol contexts when a data session is established; other data structures that facilitate routing of packetized data also can be generated. To that end, in an aspect, PS gateway node(s) 918 can comprise a tunnel interface (e.g., tunnel termination gateway (TTG) in 3GPP UMTS network(s) (not shown)) which can facilitate packetized communication with disparate wireless network(s), such as Wi-Fi networks.

In communication device 900, mobile network platform 910 also comprises serving node(s) 916 that, based upon available radio technology layer(s) within technology resource(s) in the radio access network 920, convey the various packetized flows of data streams received through PS gateway node(s) 918. It is to be noted that for technology resource(s) that rely primarily on CS communication, server node(s) can deliver traffic without reliance on PS gateway node(s) 918; for example, server node(s) can embody at least in part a mobile switching center. As an example, in a 3GPP UMTS network, serving node(s) 916 can be embodied in serving GPRS support node(s) (SGSN).

For radio technologies that exploit packetized communication, server(s) 914 in mobile network platform 910 can execute numerous applications that can generate multiple disparate packetized data streams or flows, and manage (e.g., schedule, queue, format ...) such flows. Such application(s) can comprise add-on features to standard services (for example, provisioning, billing, customer support ...) provided by mobile network platform 910. Data streams (e.g., content(s) that are part of a voice call or data session) can be conveyed to PS gateway node(s) 918 for authorization/authentication and initiation of a data session, and to serving node(s) 916 for communication thereafter. In addition to application server, server(s) 914 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 910 to ensure network’s operation and data integrity in addition to authorization and authentication procedures that CS gateway node(s) 912 and PS gateway node(s) 918 can enact. Moreover, provisioning server(s) can provision services from external network(s) like networks operated by a disparate service provider; for instance, WAN 950 or Global Positioning System (GPS) network(s) (not shown). Provisioning server(s) can also provision coverage through networks associated to mobile network platform 910 (e.g., deployed and operated by the same service provider), such as distributed antennas that enhance wireless service coverage by providing more network coverage.

It is to be noted that server(s) 914 can comprise one or more processors configured to confer at least in part the functionality of mobile network platform 910. To that end, the one or more processors can execute code instructions stored in memory 930, for example. It should be appreciated that server(s) 914 can comprise a content manager, which operates in substantially the same manner as described hereinbefore.

In example embodiment of communication device 900, memory 930 can store information related to operation of mobile network platform 910. Other operational information can comprise provisioning information of mobile devices served through mobile network platform 910, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 930 can also store information from at least one of telephony network(s) 940, WAN 950, SS7 network 960, or enterprise network(s) 970. In an aspect, memory 930 can be, for example, accessed as part of a data store component or as a remotely connected memory store.

In order to provide a context for the various aspects of the disclosed subject matter, FIG. 9, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

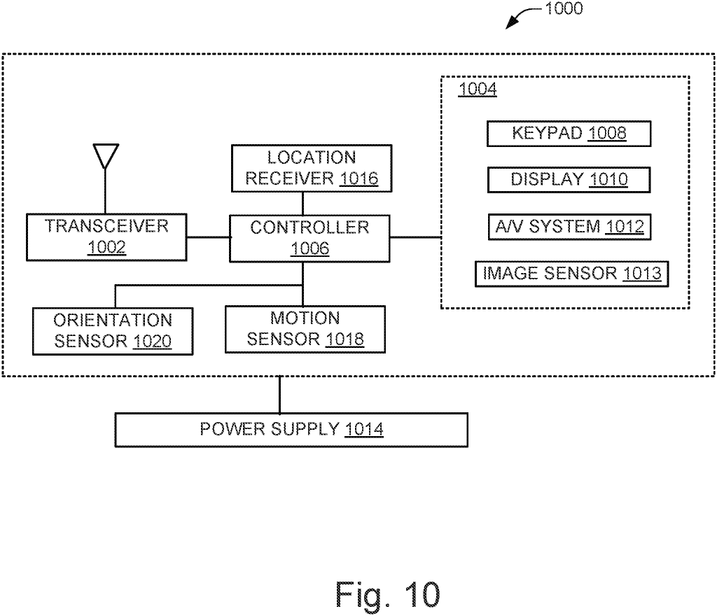

Turning now to FIG. 10 an illustrative embodiment of a communication device 1000 is shown. The communication device 1000 can serve as an illustrative embodiment of devices such as user computer device 102 as well as other devices. For example, communication device 1000 can facilitate in whole or in part an online content delivery system and method which conducts an auction among bids to serve a directed content to a web page to fill an impression and implement a frequency capping process, even in the absence of identification information such as browser cookies for users.

The communication device 1000 can comprise a wireline and/or wireless transceiver 1002 (herein transceiver 1002), a user interface (UI) 1004, a power supply 1014, a location receiver 1016, a motion sensor 1018, an orientation sensor 1020, and a controller 1006 for managing operations thereof. The transceiver 1002 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 1002 can also be adapted to support circuit-switched wireline access technologies (such as PSTN), packet-switched wireline access technologies (such as TCP/IP, VoIP, etc.), and combinations thereof.

The UI 1004 can include a depressible or touch-sensitive keypad 1008 with a navigation mechanism such as a roller ball, a joystick, a mouse, or a navigation disk for manipulating operations of the communication device 1000. The keypad 1008 can be an integral part of a housing assembly of the communication device 1000 or an independent device operably coupled thereto by a tethered wireline interface (such as a USB cable) or a wireless interface supporting for example Bluetooth®. The keypad 1008 can represent a numeric keypad commonly used by phones, and/or a QWERTY keypad with alphanumeric keys. The UI 1004 can further include a display 1010 such as monochrome or color LCD (Liquid Crystal Display), OLED (Organic Light Emitting Diode) or other suitable display technology for conveying images to an end user of the communication device 1000. In an embodiment where the display 1010 is touch-sensitive, a portion or all of the keypad 1008 can be presented by way of the display 1010 with navigation features.

The display 1010 can use touch screen technology to also serve as a user interface for detecting user input. As a touch screen display, the communication device 1000 can be adapted to present a user interface having graphical user interface (GUI) elements that can be selected by a user with a touch of a finger. The display 1010 can be equipped with capacitive, resistive or other forms of sensing technology to detect how much surface area of a user’s finger has been placed on a portion of the touch screen display. This sensing information can be used to control the manipulation of the GUI elements or other functions of the user interface. The display 1010 can be an integral part of the housing assembly of the communication device 1000 or an independent device communicatively coupled thereto by a tethered wireline interface (such as a cable) or a wireless interface.

The UI 1004 can also include an audio system 1012 that utilizes audio technology for conveying low volume audio (such as audio heard in proximity of a human ear) and high-volume audio (such as speakerphone for hands free operation). The audio system 1012 can further include a microphone for receiving audible signals of an end user. The audio system 1012 can also be used for voice recognition applications. The UI 1004 can further include an image sensor 1013 such as a charged coupled device (CCD) camera for capturing still or moving images.

The power supply 1014 can utilize common power management technologies such as replaceable and rechargeable batteries, supply regulation technologies, and/or charging system technologies for supplying energy to the components of the communication device 1000 to facilitate long-range or short-range portable communications. Alternatively, or in combination, the charging system can utilize external power sources such as DC power supplied over a physical interface such as a USB port or other suitable tethering technologies.

The location receiver 1016 can utilize location technology such as a global positioning system (GPS) receiver capable of assisted GPS for identifying a location of the communication device 1000 based on signals generated by a constellation of GPS satellites, which can be used for facilitating location services such as navigation. The motion sensor 1018 can utilize motion sensing technology such as an accelerometer, a gyroscope, or other suitable motion sensing technology to detect motion of the communication device 1000 in three-dimensional space. The orientation sensor 1020 can utilize orientation sensing technology such as a magnetometer to detect the orientation of the communication device 1000 (north, south, west, and east, as well as combined orientations in degrees, minutes, or other suitable orientation metrics).

The communication device 1000 can use the transceiver 1002 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 1006 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 900.

Other components not shown in FIG. 10 can be used in one or more embodiments of the subject disclosure. For instance, the communication device 1000 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn’t otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x = (x1, x2, x3, x4, ..., xn), to a confidence that the input belongs to a class, that is, f(x) = confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

The present disclosure relates to systems and methods for delivering advertisements according to an estimated delivery rate for impressions according to at least the examples provided in the sections below.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
maintaining a covisitation graph, the covisitation graph indicating a plurality of related websites, the covisitation graph further comprising probability values related to the probability that future visitors to a first website of the plurality of related websites will visit one or more of the other websites of the plurality of related websites;
estimating an expected number of impressions seen, within a predetermined period of time, on one or more of the websites indicated on the covisitation graph;
identifying a frequency cap, wherein the frequency cap defines a limit of impressions of an item of directed content to be shown to a current visitor within a predetermined period of time;
based on the expected number of impressions and the probability values of related websites and the frequency cap, determining a delivery rate for impressions of the directed content for the current visitor of the first website; and
delivering impressions of the directed content based on the delivery rate.

2. The device of claim 1, wherein the determining an expected number of impressions seen on the first website for future visitors of the first website comprises:
determining a ratio of a total number of impressions seen on the first website to a number of distinct user identifiers seen on the first website.

3. The device of claim 2, wherein the operations further comprise:
identifying past visitors visiting the first website, wherein the identifying is based on information about the past visitors other than browser cookies; and
determining the number of distinct user identifiers based on identified visitors visiting the first website.

4. The device of claim 3, wherein the operations further comprise:
determining, from data of the covisitation graph, an expected number of impressions seen on a first website for visitors of the first website;
identifying, from data of the covisitation graph, one or more related websites having a relation to the first website;
identifying the users visiting the first website based on a respective internet protocol address associated with a respective visitor visiting the first website; and
identifying the visitors visiting the first website based on other identifying information associated with the respective visitor visiting the first website.

5. The device of claim 1, wherein the determining a probability for a visitor of the first website to be a visitor of each respective related website of the one or more related websites comprises:
determining a ratio of a number of distinct user identifiers seen on the one or more related websites to a number of distinct user identifiers seen on the first website.

6. The device of claim 1, wherein the estimating an expected total number of impressions seen on the first website and the one or more related websites comprises:
multiplying an average number of impressions on each related website of the one or more related website by the probability the current visitor of the first website will visit each respective related website of the one or more related websites.

7. The device of claim 1, wherein the operations further comprise:
determining a random number;
comparing the random number with the delivery rate; and
delivering impressions of the directed content according to the comparing.

8. The device of claim 1, wherein the operations further comprise:
receiving a bid request, the bid request identifying a website and opportunity to show a directed content to the current visitor to the website; and
submitting a bid to an auction to determine the directed content to be shown to the current visitor to the website according to the delivery rate.

9. The device of claim 8, wherein the operations further comprise:
estimating a win rate of previous auctions to determine directed contents to be shown; and
adjusting the delivery rate according to the win rate.

10. The device of claim 8, wherein the operations further comprise:
receiving the request data in the online directed content delivery platform, the request data including data from visitors with known identification information and data from unidentified visitors;
anonymizing the request data, forming anonymous request data; and
storing the anonymous request data in a database.

11. A non-transitory machine-readable medium, comprising executable instructions that, when executed by a processing system including a processor, facilitate performance of operations, the operations comprising:
receiving, from an owner of a directed content, data defining a frequency cap, the frequency cap corresponding to a number of impressions of the directed content to be shown to a current visitor visiting a first website;
retrieving directed content request data in an online directed content delivery platform, the directed content request data related to directed contents shown to past users visiting the first website;
determining, from the directed content request data, an expected number of impressions seen on the first website;
identifying, from the directed content request data, one or more related websites having a relation to the first website;
determining, from the directed content request data, a probability for a current visitor of the first website to visit of each respective related website of the one or more related websites;
determining an expected number of impressions seen on each respective related website for the current visitor behind a bid request received on the first website;
estimating an expected total number of impressions seen on the first website and the one or more related websites for the current visitor behind a bid request received on the first website;
based on the expected total number of impressions and the data defining the frequency cap, determining a delivery rate for impressions of the directed content; and delivering impressions of the directed content based on the delivery rate.

12. The non-transitory machine-readable medium of claim 11, wherein the operations further comprise:
identifying visitors visiting the first website, wherein the identifying is based on information about the visitors other than browser cookies.

13. The non-transitory machine-readable medium of claim 12, wherein the determining an expected number of impressions seen on a first website for visitors of the first website comprises:
determining a total number of impressions seen on the first website as a first value;
determining a number of distinct user identifiers seen on the first website as a second value; and
determining a ratio between the first value and the second value as the expected number of impressions seen on the first website.

14. The non-transitory machine-readable medium of claim 13, wherein the operations further comprise:
determining the number of distinct user identifiers based on identified visitors visiting the first website.

15. The non-transitory machine-readable medium of claim 11, wherein the estimating an expected total number of impressions seen on the first website and the one or more related websites comprise:
multiplying an average number of impressions on each related website of the one or more related website by the probability that the current visitor of the first website will visit each respective related website of the one or more related websites.

16. The non-transitory machine-readable medium of claim 11, wherein the operations further comprise:
receiving bid requests, each bid request of the bid requests identifying a website and opportunity to show the directed content to the current visitor to the website;
responsive to the bid requests, submitting bids to an auction to determine the directed content to be shown to the current visitor to the website according to the delivery rate;
estimating a win rate of previous auctions to determine the directed content to be shown to visitors to the websites; and
adjusting the delivery rate according to the win rate.

17. A method, comprising:
receiving, by a processing system including a processor, information defining a frequency cap for a directed content to be shown to visitors of an online directed content system, wherein identities of the visitors are unknown to the processing system;
identifying, by the processing system, cross-site browsing patterns of a selected sample of past users accessing a plurality of websites in the online directed content system to create a covisitation graph;
based on the covisitation graph, estimating, by the processing system, a delivery rate for impressions for each website of the plurality of websites; and
delivering, by the processing system, directed contents according to the delivery rate.

18. The method of claim 17, further comprising:
selecting, by the processing system, the sample of past users based on selecting users for whom identification information is available.

19. The method of claim 17, comprising:
determining, by the processing system, an expected number of impressions seen on a first website for visitors of the first website;
identifying, by the processing system, one or more related websites having a relation to the first website;
determining, by the processing system, a probability for a current visitor of the first website to visit each respective related website of the one or more related websites;
determining an expected number of impressions seen on each respective related website for the current visitor behind a bid request received on the first website;
estimating, by the processing system, an expected total number of impressions seen on the first website and the one or more related websites for the current visitor behind the bid request received on the first website based on the expected number of impressions seen on each respective related website for the current visitor behind the bid request received on the first website; and
estimating, by the processing system, a delivery rate for impressions based on the expected total number of impressions.

20. The method of claim 17, comprising:
determining, by the processing system, a random number;
comparing, by the processing system, the random number with the delivery rate; and
delivering, by the processing system, directed contents when the random number is less than or equal to the delivery rate.
